(19) United States
(12) Patent Application Publication
(10) Pub. No.: US 2025/0306566 A1
(43) Pub. Date: Oct. 2, 2025

(54) SYSTEMS AND METHODS FOR DECISION MAKING AND CONTROL IN MULTI-AGENT SYSTEMS

(71) Applicant: General Dynamics Mission Systems, Inc., Fairfax, VA (US)

(72) Inventors: Patrick V. Haggerty, St. Louis Park, MN (US); Benjamin A. Strasser, Minneapolis, MN (US)

(73) Assignee: General Dynamics Mission Systems, Inc., Fairfax, VA (US)

(21) Appl. No.: 18/618,235

(22) Filed: Mar. 27, 2024

(51) Int. Cl. G05B 19/4155

(52) U.S. Cl. CPC G05B 19/4155; G05B 2219/32306

(57) ABSTRACT

Systems and methods are provided for decision making and/or control in multi-agent systems. The methods include receiving objectives of a mission that includes agents performing actions in an operational area, activating an active mode selected from two or more modes for a first agent, wherein each of the modes include actions that the first agent may perform and control algorithms for executing the actions, and directing the first agent by: initiating a current action based on the control algorithms, receiving and processing sensor data and/or communication data from the agents and/or other systems, updating a hybrid state estimator based on the sensor data and/or communication data, generating an estimation of a current state of the mission with the hybrid state estimator, and activating one of the modes for the first agent in accordance with confidence-based transition logic based on the estimation generated by the hybrid state estimator.

### TECHNICAL FIELD OF THE INVENTION

The present invention generally relates to automated decision and control systems, and more particularly relates to systems and methods for automated decision and control in complex dynamical systems comprising multiple interacting agents.

### BACKGROUND OF THE INVENTION

Multi-agent hybrid dynamical systems represent a class of complex systems that involve both continuous dynamics (e.g., modeled by differential equations) and discrete dynamics (e.g., modeled by discrete events or transitions). These systems are composed of multiple interacting agents, where each agent's behavior is governed by both continuous and discrete processes. Applications of multi-agent hybrid dynamical systems are varied and may include robotics, control systems, traffic management, distributed computing, and social systems modeling. Designing and analyzing these systems may require expertise in both continuous and discrete dynamics, as well as techniques from fields such as control theory, optimization, and multi-agent systems. Despite the challenges, there is an ongoing desire for improved systems and methods capable of completing increasingly complex missions in an efficient manner.

### SUMMARY OF THE INVENTION

This section provides a general summary of the disclosure and is not a comprehensive disclosure of its full scope or all of its features.

In various embodiments, a method is provided that includes receiving, by a controller having one or more processors, input data indicative of one or more objectives of a mission, wherein the mission includes agents performing actions in an operational area, activating, with the controller, an active mode selected from two or more modes for at least a first agent of the agents, wherein each of the modes include actions that the first agent may perform during the mission and control algorithms for executing each of the actions, and directing, with the one or more processors of the controller, at least the first agent during the mission by: initiating a current action selected from the actions of the active mode based on the control algorithms of the active mode in response to activation of the active mode, receiving and processing sensor data and/or communication data received from one or more of the agents and/or other systems monitoring the operational area in response to completion of the current action, updating a hybrid state estimator based on the sensor data and/or communication data in response to receiving and processing the sensor data and/or communication data, generating an estimation of a current state of the mission with the hybrid state estimator in response to completion of the hybrid state estimator update, and activating one of the two or more modes as the active mode for at least the first agent in accordance with confidence-based transition logic based on the estimation generated by the hybrid state estimator in response to completion of generation of the estimation by the hybrid state estimator.

In various embodiments, a system is provided that includes two or more agents configured to operate within an operational area during a mission, and a controller configured to, with one or more processors, receive input data indicative of one or more objectives of the mission, wherein the mission includes the agents performing actions in the operational area, activate, for at least a first agent of the agents, an active mode selected from two or more modes, wherein each of the modes include actions that the first agent may perform during the mission and control algorithms for executing each of the actions, and direct at least the first agent during the mission by: initiating a current action selected from the actions of the active mode based on the control algorithms of the active mode in response to activation of the active mode, receiving and processing sensor data and/or communication data received from the one or more of the agents and/or other systems monitoring the operational area in response to completion of the current action, updating a hybrid state estimator based on the sensor data and/or communication data in response to receiving and processing the sensor data and/or communication data, generating an estimation of a current state of the mission with the hybrid state estimator in response to completion of the hybrid state estimator update, and activating one of the two or more modes as the active mode in accordance with confidence-based transition logic based on the estimation generated by the hybrid state estimator in response to completion of generation of the estimation by the hybrid state estimator.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations and are not intended to limit the scope of the present disclosure.

FIG. 1 is a functional block diagram schematically representing an executive control system for performing decision making and/or control functions for a multi-agent system in accordance with exemplary embodiments;

FIG. 2 is a flowchart illustrating a method for performing decision making and/or control functions for a multi-agent system in accordance with exemplary embodiments;

FIG. 3 is a flowchart illustrating a method for performing decision making and/or control functions for a multi-agent system with a perimeter defense mission in accordance with exemplary embodiments;

FIG. 4 schematically represents an operational area for the perimeter defense mission of FIG. 3 in accordance with exemplary embodiments;

FIG. 5 is a flowchart illustrating a method for performing decision making and/or control functions for a multi-agent system with a search and track mission in accordance with exemplary embodiments;

FIG. 6 schematically represents an operational area for the search and track mission of FIG. 5 in accordance with exemplary embodiments;

FIG. 7 schematically represents a heatmap and confidence score for a first region of the operational area of FIG. 6 in accordance with exemplary embodiments;

FIG. 8 schematically represents a heatmap and confidence score for a second region of the operational area of FIG. 6 in accordance with exemplary embodiments; and

FIG. 9 schematically represents a heatmap and confidence score for a third region of the operational area of FIG. 6 in accordance with exemplary embodiments.

Corresponding reference numerals indicate corresponding parts throughout the several views of the drawings.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Examples of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that examples of the present disclosure may be practiced in conjunction with any number of systems, and that the systems described herein is merely examples of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an example of the present disclosure.

Briefly, systems and methods disclosed herein provide for automated decision and control in multi-agent hybrid dynamical systems. These systems are composed of multiple interacting agents, where each agent's behavior is governed by both continuous and discrete processes. The continuous processes represent the evolution of the system's state variables over time according to differential equations. These equations govern how the agents' states change continuously based on, for example, factors like the agents' locations, the agents' motion, interaction forces with the agents, or environmental influences on the agents. The discrete processes represent abrupt changes or events in the system, such as, for example, state transitions, communication events, and/or decision-making processes. These discrete process events can occur at specific times or under certain conditions, and they often influence the system's behavior or state. The control decisions in the continuous space, referred to herein as “physical control,” may include multi-agent control in which each agent moves about physical space to complete given objectives. The control decisions in the discrete space, referred to herein as “executive control,” may include high-level goal-oriented decisions. A discrete element is referred to herein a “mode,” and each mode determines how the continuous states evolve by determining algorithms or methods for continuous or periodic control in response to environmental stimuli.

The systems and methods disclosed herein will be discussed in relation to missions, that is, a set of tasks featuring interacting subtasks required to complete to achieve a goal or objective. Each of the agents may have its own goals, knowledge, and capabilities, and may be capable of interacting with each other and the environment to achieve their individual or collective objectives. The interactions between agents can be both continuous and discrete. Continuous interactions may involve physical interactions such as coupled control algorithms (e.g. a leader/follower behavior in which one agent attempts to follow another), while discrete interactions may include communication protocols, coordination mechanisms, or decision-making processes. Due to the interactions between agents and the combination of continuous and discrete processes, the systems may exhibit emergent behavior, that is, complex behaviors or patterns that arise from the interactions of the individual agents, rather than being explicitly programmed.

The systems and methods disclosed herein may include associating discrete modes to high level mission tasks. Each mode may specify a control algorithm designed to accomplish the underlying goal of that mode. A mission progresses as the hybrid dynamical system evolves; agents use control algorithms to navigate an operational area and complete tasks, switching to new modes and/or tasks as they complete current ones. For convenience, the systems and methods disclosed herein are discussed in relation to certain applications; however, the system and methods are not limited to these examples and may be used for various other applications. Specific nonlimiting examples of applications for the systems and methods disclosed herein may include military operations, crop surveillance, land and resource surveying, wildlife migration monitoring, search and rescue activities, automated exploratory surgery, and autonomous and semi-autonomous vehicles.

The agents of the systems and methods disclosed herein may be various autonomous mobile platforms, manned mobile platforms, or individuals. In some examples, one or more of the agents may be various types of aircraft. It should be noted that the term aircraft, as utilized herein, may include any manned or unmanned object capable of flight. Examples of aircraft may include, but are not limited to, fixed-wing aerial vehicles (e.g., propeller-powered or jet powered), rotary-wing aerial vehicles (e.g., helicopters), manned aircraft, unmanned aircraft (e.g., unmanned aerial vehicles, or UAVs), delivery drones, etc.

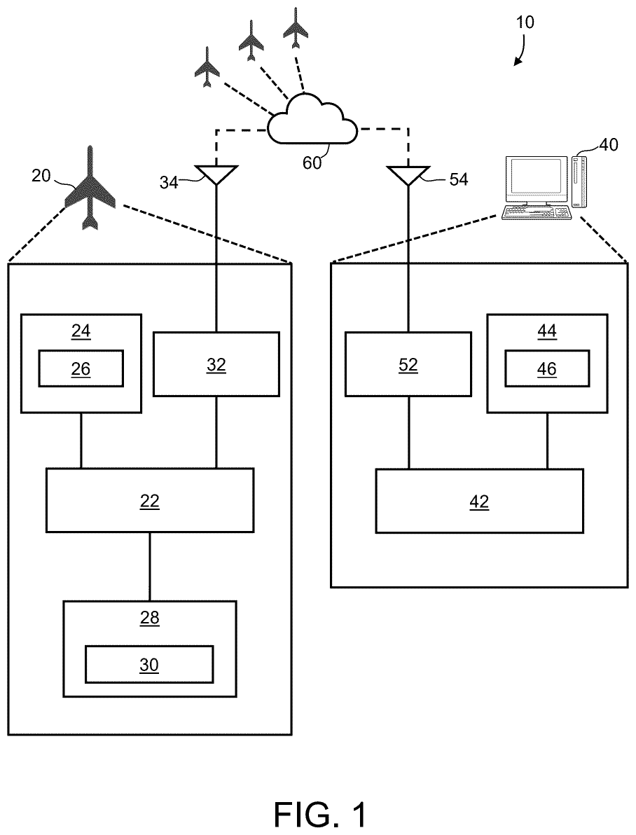

Referring now to FIG. 1, an agent 20, in this example a UAV, a remote system 40, and certain systems of each are illustrated in accordance with an exemplary and nonlimiting embodiment of the present disclosure. An executive control system 10 may be utilized onboard the agent 20, on the remote system 40 and communicated to the agent 20, or both as described herein. The system 10 may include any number of agents the same as or different from the agent 20. As schematically depicted in FIG. 1, the agent 20 may include and/or be functionally coupled to the following components or subsystems, each of which may assume the form of a single device or multiple interconnected devices, including, but not limited to, a controller 22 operationally coupled to computer-readable storage media or memory 24, onboard data sources 28 including, for example, an array of geospatial and flight parameter sensors 30, and a communication system 32 including an antenna 34. The remote system 40 may include and/or be functionally coupled to the following components or subsystems, each of which may assume the form of a single device or multiple interconnected devices, including, but not limited to, a controller 42 operationally coupled to computer-readable storage media or memory 44 and a communication system 52 including an antenna 54. The communication systems 32 and 52 may, via the antennas 34 and 54, respectively, wirelessly transmit data to and receive data therebetween through a wireless communication network 60. Although schematically illustrated in FIG. 1 as a single unit, the individual elements and components of the system 10 can be implemented in a distributed manner utilizing any practical number of physically distinct and operatively interconnected pieces of hardware or equipment.

The term “controller,” as appearing herein, broadly encompasses those components utilized to carry-out or otherwise support the processing functionalities of the system 10. Accordingly, the controllers 22 and 42 may encompass or may be associated with any number of individual processors, flight control computers, navigational equipment pieces, computer-readable memories (including or in addition to the memories 24 and 44), power supplies, storage devices, interface cards, and other standardized components.

In various embodiments, the controllers 22 and 42 may each include at least one processor, a communication bus, and a computer readable storage device or media. The processor performs the computation and control functions of the respective controller 22 or 42. The processor can be any custom made or commercially available processor, a central processing unit (CPU), a graphics processing unit (GPU), an auxiliary processor among several processors associated with the controller 22 or 42, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 or 42. The bus serves to transmit programs, data, status and other information or signals between the various components. The bus can be any suitable physical or logical means of connecting computer systems and components. This includes, but is not limited to, direct hard-wired connections, fiber optics, infrared, and wireless bus technologies.

The instructions may include one or more separate programs, each of which comprises executable instructions for implementing logical functions. The instructions, when executed by the processor, receive and process signals from, for example, the sensors 30, perform logic, calculations, methods and/or algorithms, and generate data based on the logic, calculations, methods, and/or algorithms. Although only one of each of the controllers 22 and 42 are shown in FIG. 1, embodiments of the agent 20 and the remote system 40 may include any number of controllers 22 and 42 that communicate over any suitable communication medium or a combination of communication mediums and that cooperate to process the sensor signals, perform logic, calculations, methods, and/or algorithms, and generate data. In various embodiments, the controllers 22 and 42 each include or cooperates with at least one firmware and software program (generally, computer-readable instructions that embody an algorithm) for carrying-out the various process tasks, calculations, and control/display functions described herein. During operation, each of the controllers 22 and 42 may be programmed with and execute at least one firmware or software program, for example, programs 26 and/or 46, that embodies one or more algorithms, to thereby perform the various process steps, tasks, calculations, and control/display functions described herein.

The controllers 22 and 42 may exchange data with each other and/or one or more external sources to support operation of the system 10 in various embodiments. In this case, bidirectional wireless data exchange may occur via the communication systems 32 and 52 over the communication network 60, such as a public or private network implemented in accordance with Transmission Control Protocol/Internet Protocol architectures or other conventional protocol standards. Encryption and mutual authentication techniques may be applied, as appropriate, to ensure data security.

In various embodiments, each of the communication systems 32 and 52 are configured to support instantaneous (i.e., real time or current) communications between on-board systems, the controllers 22 and 42, and the one or more external sources. Each of the communication systems 32 and 52 may incorporate one or more transmitters, receivers, and the supporting communications hardware and software required for components of the system 10 to communicate as described herein. In various embodiments, the communication systems 32 and/or 52 may have additional communications not directly relied upon herein, such as bidirectional pilot-to-ATC (air traffic control) communications via a datalink, and any other suitable radio communication system that supports communications between the agent 20, the remote system 40, and various external source(s).

Each of the memories 24 and 44 may encompass any number and type of storage media suitable for storing computer-readable code or instructions, such as the programs 26 and 46, as well as other data generally supporting the operation of the system 10. As can be appreciated, each of the memories 24 and 44 may be part of their respective controller 22 or 42, separate from their respective controller 22 or 42, or part of their respective controller 22 or 42 and part of a separate system. Each of the memories 24 and 44 may be any suitable type of storage apparatus, including various different types of direct access storage and/or other memory devices.

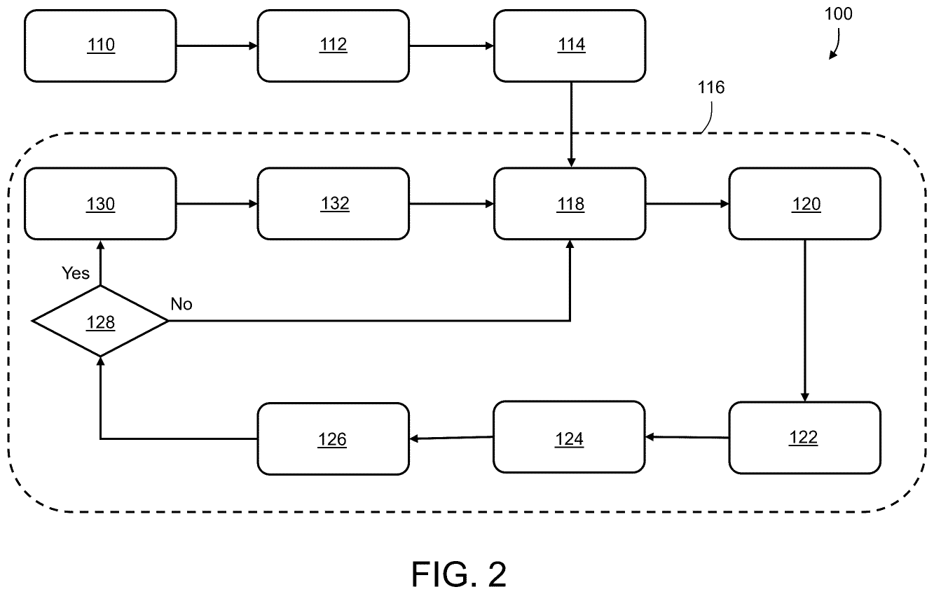

FIG. 2 is a flowchart illustrating a framework or method 100 for automated decision making and control in a multi-agent system in accordance with various examples. As can be appreciated in light of the disclosure, the order of operation within the method 100 is not limited to the sequential execution as illustrated in FIG. 2, but may be performed in one or more varying orders as applicable and in accordance with the present disclosure. In various examples, the method 100 may be implemented as a software module or application executed on one or more processors of one or more controllers. The controller(s) may be local to one or more of the agents, may be remote to the agents and in communication therewith via a wireless communication network, or both. As such, the method 100 may be implemented to the system as a whole with decisions and commands being provided for all of the agents, or the method 100 may be implemented on each individual agent independently to provide decisions and commands to the corresponding agent.

In one example, the method 100 may start at step 110 and may include receiving, by a controller having one or more processors, input data indicative of one or more objectives of a mission, wherein the mission includes agents performing actions in an operational area. The objectives may include, for example, various intents, goals, and/or specifications of the mission. In some examples, the input data may be user input received from a user interface. In some examples, the mission may be selected from multiple preprogrammed missions.

At step 112, the method 100 may include producing modes, mode transitions, state estimators, and/or control algorithms. In some examples, this information may be user input received from a user interface. In some examples, this information may be preprogrammed information associated with the mission described or selected in step 110 and, optionally, may be automatically generated in response to selection of the mission. Each of the modes includes actions that the agents may perform during the mission while the corresponding mode is active, the mode transitions include confidence-based logic for changing between each of the modes, the state estimators are configured to generate estimations of a state of the mission, the control algorithms are configured to execute each of the actions in the corresponding mode. At step 114, the method 100 may include selecting, initiating, or activating an initial mode. As used herein, the mode that is active or currently being executed is referred to as the active mode.

While a mode is active, the method 100 may include, at step 116, continuously or periodically directing each of the agents during the mission with the processor(s) of the controller(s), for example, until certain conditions are reached, such as completion of the mission or until receiving a command to cease the mission. In some examples, directing the agents may include a loop defined by steps 118-132 of FIG. 2. In some examples, directing of the agents may begin by initiating a current action selected from the actions of the active mode based on the control algorithms of the active mode. Initiation of the current action may be performed automatically in response to activation of the active mode. In the example of FIG. 2, initiation of the current action may include: determining, at step 118, which of the actions of the active mode to initiate as the current action based on the control algorithms of the active mode, transmitting, at step 120, a message to the other agents or the remote system 40 indicative of the current action, sensor readings, state estimations, etc. (e.g., for situational awareness of the other agents or the system as a whole), and actuating, at step 122, a physical controller of the agent to perform the current action (if applicable).

At step 124, the method 100 may include receiving and processing sensor data and/or communication data received from the agents and/or other systems monitoring the operational area. Receiving and processing such data may be performed in response to completion of the current action.

At step 126, the method 100 may include updating a hybrid state estimator based on the sensor data and/or communication data. The state estimator may be updated in response to receiving and processing the sensor data and/or communication data. The method 100 may include generating an estimation of a current state of the mission with the state estimator. Generation of the estimation may be performed in response to completion of the state estimator update. The estimation may include discrete elements, continuous elements, or both (e.g., hybrid state estimator).

At step 128, the method 100 may include determining whether to change the active mode based on the estimation generated by the state estimator. The determination as whether to change the active mode may be performed in response to completion of generation of the estimation by the state estimator. In some examples, the estimation generated by the state estimator may include variables such as the physical states of the agents (e.g., the locations thereof), the actual or predicted locations of regions or objects of interest (e.g., targets being searched for), a likelihood of completing mission objects, and various other criteria and parameters. If at step 128, a determination is made to not change the active mode, the method 100 may initiate a second or subsequent action, for example, by returning to and repeating step 118. If at step 128, a determination is made to change the active mode, the method 100 may continue to step 130 including changing the active mode in accordance with confidence-based transition logic. At step 132, the method 100 may include initiating control algorithms and state estimators for the new active mode. Thereafter, the method 100 may initiate a subsequent action, for example, by returning to and repeating step 118. The step 116 may continue in a loop until the mission has been completed, a command is received to cease the mission, or other mission end criteria have been met.

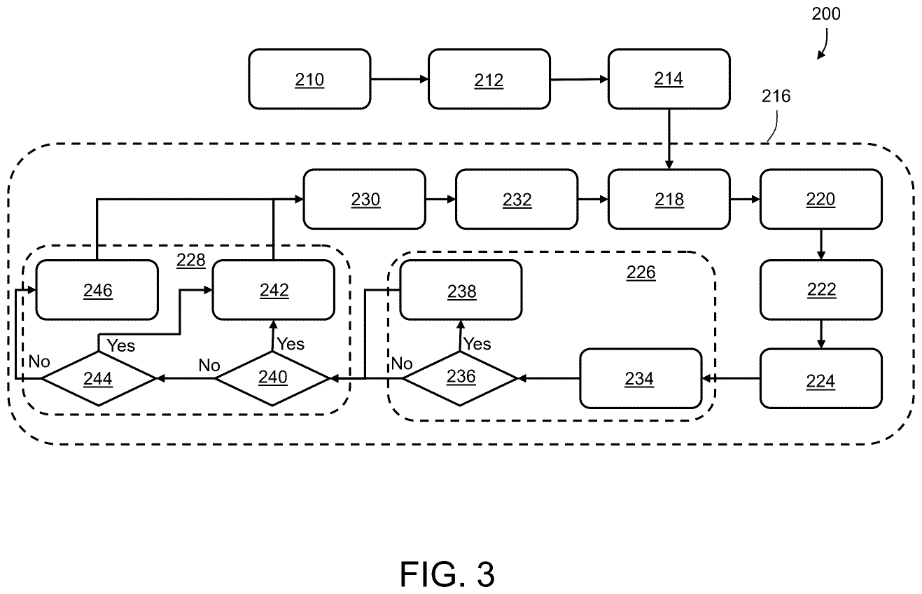

FIGS. 3-9 illustrate various nonlimiting examples of specific applications of the method 100, described as methods 200 and 400. It should be noted that these examples are merely for illustrative purposes and the method 100 of FIG. 2 may have other applications configurations. For convenience, consistent reference numbers are used throughout FIGS. 3-9 to identify the same or functionally related/equivalent elements, but with a numerical prefix (1, 2, or 3, etc.) added to distinguish the particular example from other examples of the of the figures. In view of similarities between the examples, the following discussion of FIGS. 3-9 will focus primarily on aspects of the examples that differ from the other examples in some notable or significant manner. Other aspects of the examples not discussed in any detail can be, in terms of structure, function, materials, etc., essentially as was described for one or more of the other examples, including the example of FIG. 2.

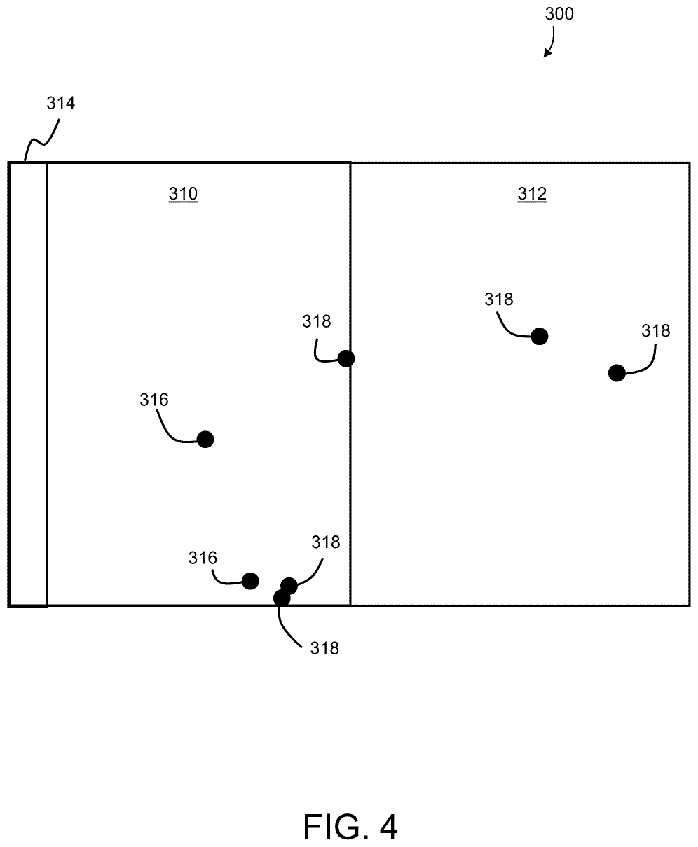

Referring now to FIG. 3, a flowchart is presented that illustrates the method 200 for automated decision making and control in a multi-agent system for a perimeter defense mission in accordance with various examples. In this example, the mission may include a first team of “defenders” (i.e., agents) having a goal of intercepting a second team of “attackers” and preventing them from breaching a threshold, such as a perimeter or boundary. For convenience, the method 200 will be discussed in reference to simple operational area 300 schematically represented in FIG. 4; however, the method 200 is not limited to the operational area 300. In the example of FIG. 4, the operational area 300 includes a defender zone 310 to which the defenders 316 are restricted, an attacker zone 312 adjacent to the defender zone 310 in which the attackers 318 originate, and a boundary zone 314 adjacent to the defender zone 310 and opposite the attacker zone 312. During the mission, the attackers 318 move toward the boundary zone 314 in an attempt to reach and breach the boundary zone 314 prior to being intercepted by the defenders 316.

At step 210, the method 200 may include establishing the objectives of the mission including, for example, keeping the attackers 318 from breaching the boundary zone 314.

At step 212, the method 200 may include producing modes, mode transitions, state estimators, and/or control algorithms of the perimeter defense mission. For example, “patrol” and “engage” modes may be produced, mode transitions may be produced for transitioning between the patrol and engage modes, state estimators may be produced with temporal logic for evaluating performance of the defenders 316, and control algorithms may be produced for controlling or directing the defenders 316 about the defender zone 310. In the patrol mode, the control algorithms may be configured to move or direct the defenders 316 about the operational area 300 to search for the attackers 318. Upon detection of one of the attackers 318, the nearby defenders 316 may switch to the engage mode and the control algorithms may be configured to cause or direct the defenders 316 to intercept the detected attackers 318. At step 214, the method 200 may include selecting and activating the patrol mode as the initial, active mode.

At step 216, the method 200 may include directing one or more of the defenders 316 during the mission. In this example, directing each of the defenders 316 may include a loop defined by steps 218-246. At step 218, the method 200 may include determining which of the actions of the active mode (e.g., initially the patrol mode) to initiate as the current action based on the control algorithms of the active mode. At step 220, the method 200 may include transmitting a message to a first of the defenders 316 indicative of the current action to be performed thereby. At step 222, the method 200 may include actuating a physical controller of the first defender 316 to perform the current action (if applicable).

At step 224, the method 200 may include receiving and processing sensor data and/or communication data received from the defenders 316 and/or other systems monitoring the operational area 300. At 226, the method 200 may include updating a state estimator based on the sensor data and/or communication data. In this example, updating the state estimator may include evaluating the temporal logic formulae at step 234. Based on the updated temporal logic formulae, the method 200 may include deciding, at step 236, as to whether the boundary zone 314 is likely to be breached by the attackers 318. If a determination is made at step 236 that the attackers 318 are likely to breach the boundary zone 314, the method 200 may include generating, at step 238, a request for assistance to one or more of the defenders 316 to intercept the attacker(s) 318 that are threatening the boundary zone, and then continuing to step 228. If a determination is made at step 236 that the attackers 318 are unlikely to breach the boundary zone 314, the method 200 may continue to step 228.

At step 228, the method 200 may include determining whether to change the active mode based on the estimation generated by the state estimator. In this example, determining whether to change the active mode for each of the defenders 316 may include, at step 240, determining whether a request for assistance has been received by the corresponding defender 316 at step 238. If a request for assistance has not been received at step 240, the method 200 may include determining, at step 244, whether one or more of the attackers 318 have been detected near each of the defenders 316. If an attacker 318 has not detected near a defender 316 at step 244, the method 200 may include, at step 246, assigning such defender 316 to patrol. If a request for help has been received at step 240 or if an attacker 318 has been detected near a defender 316, at step 244, the method 200 may include, at step 242, assigning such defender 316 to engage the nearby detected attacker 318.

Once all assignments have been made at step 228, the method 200 may include changing or maintaining the active mode for one or more of the defenders 316 by activating the corresponding mode, at step 230, for each of the defenders 316 in accordance with confidence-based transition logic and, at step 232, initiating control algorithms and state estimators for the mode(s). Thereafter, the method 200 may return to step 218 to initiate a subsequent action.

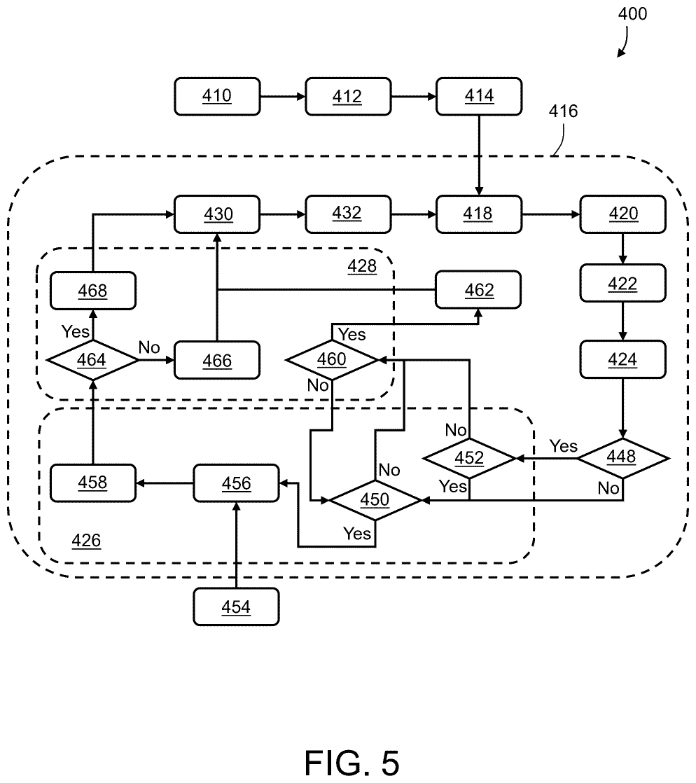

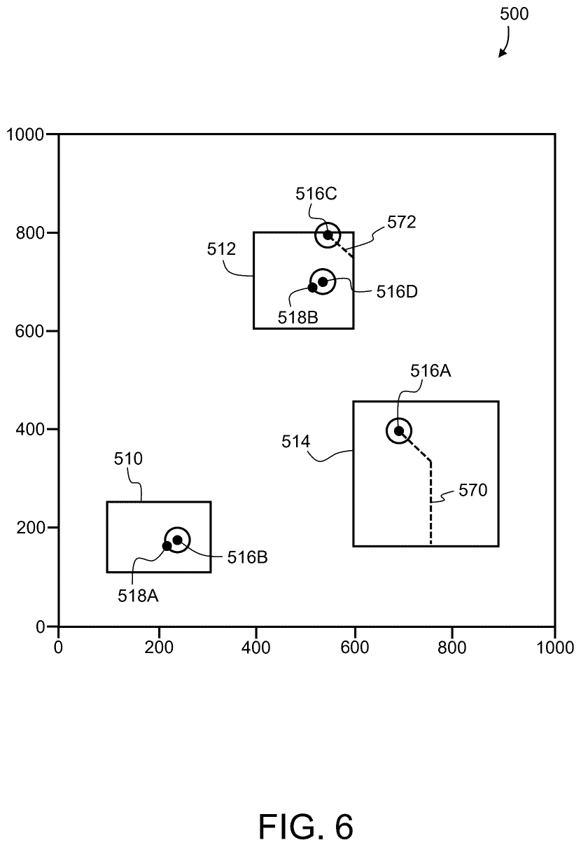

Referring now to FIG. 5, a flowchart is presented that illustrates the method 400 for automated decision making and control in a multi-agent system for a multi-region search and track mission in accordance with various examples. In this example, the mission may include a first team of “searchers” (i.e., agents) with a goal of searching separate regions of an operational area for a second team of “targets” that may be moving about the operational area. Upon detecting the targets, the searchers may track the targets, that is, follow or otherwise stay within a detectable range of the detected target(s). For convenience, the method 400 will be discussed in reference to simple operational area 500 schematically represented in FIG. 6; however, the method 400 is not limited to the operational area 500. In the example of FIG. 6, the operational area 500 includes a first region 510, a second region 512, and a third region 514. During the mission, the searchers 516A-516D (collectively referred to as the searchers 516) have a goal of attempting to find and track the targets 518A and 518B (collectively referred to as the targets 518).

At step 410, the method 400 may include establishing the objectives of the mission including, for example, performing a coordinated search of predefined regions to find and track any targets located within the regions. At step 412, the method 400 may include producing modes, mode transitions, state estimators, and/or control algorithms of the perimeter defense mission. For example, one or more “search” modes that may be specific to each region and a “track” mode may be produced, mode transitions may be produced for transitioning between the search and track modes, state estimators may be produced for evaluating performance of the searchers 516, and control algorithms may be produced for directing the searchers 516 about the operational area 500. The search mode(s) may be configured to move or direct the searchers 516 about the operational area 500 to search for the targets 518. Upon detection of one of the targets 518, the nearby searchers 516 may switch to the track mode and the control algorithms may be configured to cause or direct the searchers 516 to track the detected targets 518. In some examples, step 412 may include producing one or more target motion models configured to predict the movement of the undetected targets, a potential distribution of the targets prior to detection, and one or more search strategies. In some examples, the potential distribution of the targets prior to detection may include a hierarchical prediction of where in the operational area 500 detection of potential undetected targets 518 may occur. In some examples, the potential distribution of the targets prior to detection may be based, at least in part, on a probabilistic clustering algorithm. In some examples, the control algorithms for one or more of the search modes may include a search algorithm driven by a probabilistic target state estimate, a myopic information theoretic search algorithm, a nonmyopic information theoretic search algorithm, a greedy search algorithm, an A* search algorithm, and combinations thereof. At step 414, the method 400 may include selecting and activating one or more of the search modes as the initial, active mode, with the specific regions to be searched initially being determined by the search strategy.

At step 416, the method 400 may include directing one or more of the searchers 516 during the mission. In this example, directing each of the searchers 516 may include steps 418-468. At step 418, the method 400 may include determining which of the actions of the active mode (e.g., initially one of the search modes) to initiate as the current action for each of the searchers 516 based on the control algorithms of the active mode. At step 420, the method 400 may include transmitting a message to each of the searchers 516 and/or a remote system indicative of the current action to be performed by the agent, sensor readings, state estimations, etc. (e.g., for situational awareness and consideration when determining the actions of each of the searchers 516). At step 422, the method 400 may include actuating a physical controller of each of the searchers 516 to perform the current action assigned thereto (if applicable).

At step 424, the method 400 may include receiving and processing sensor data and/or communication data received from the searchers 516 and/or other systems monitoring the operational area 500. At step 448, the method 400 may include determining whether each of the searchers 516 are currently tracking a target.

At step 426, the method 400 may include updating a state estimator based on the sensor data and/or communication data. In this example, whether each of the searchers 516 are tracking a target at step 448, the method 400 may include determining, at step 452, whether the current track for each of the searchers 516 is stale (e.g., the searchers 516 fail to detect the target for a predetermined period of time). If the searcher 516 is not tracking a target at step 448, or if a determination is made that the current track is stale at step 452, the method 400 may include, at step 450, determining whether a new target 518 has been detected by any of the searchers 516. If a determination is made at step 450 to that a new target 518 has not been detected, the method 400 may include, at 456, updating a potential distribution of the undetected targets 518. In some examples, a target motion model may be generated at step 454. In some examples, updating the potential distribution of the targets 518 may include analyzing the sensor data and/or communication data, performing a convolution operation with the target motion model with the region of interest, and performing a Bayesian update of the potential distribution of the targets 518 between the regions. The method 400 may continue, at step 458, by synthesizing the potential distribution of the targets 518 into a confidence score by region to provide an updated search progress.

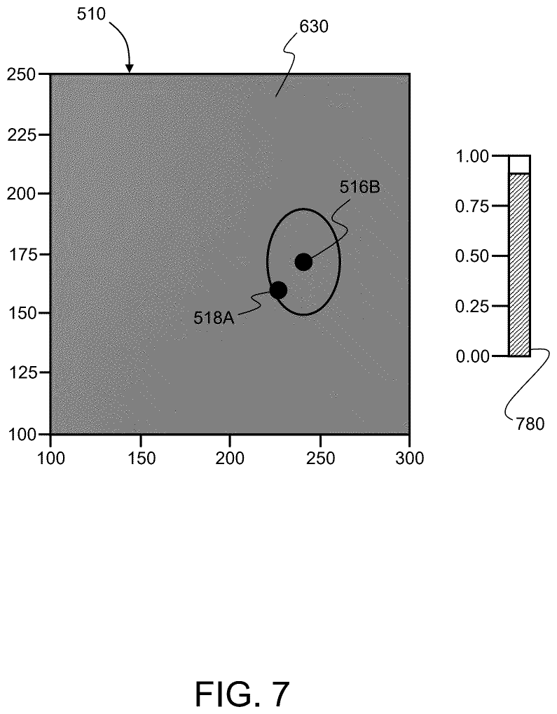

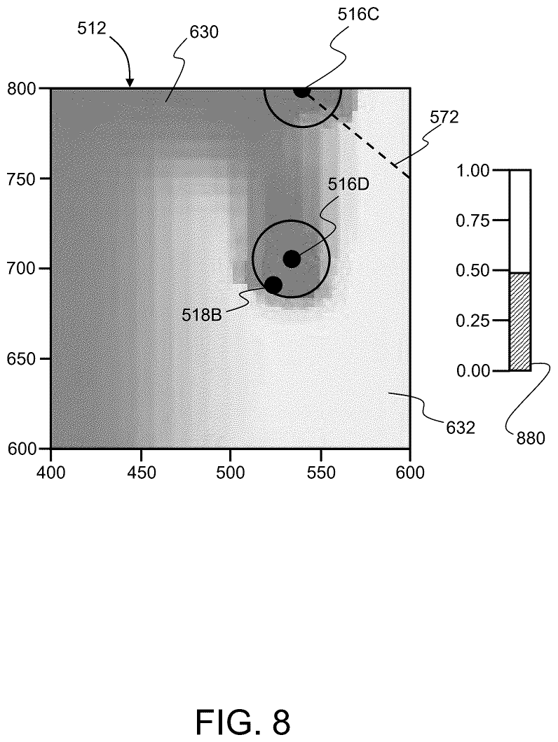

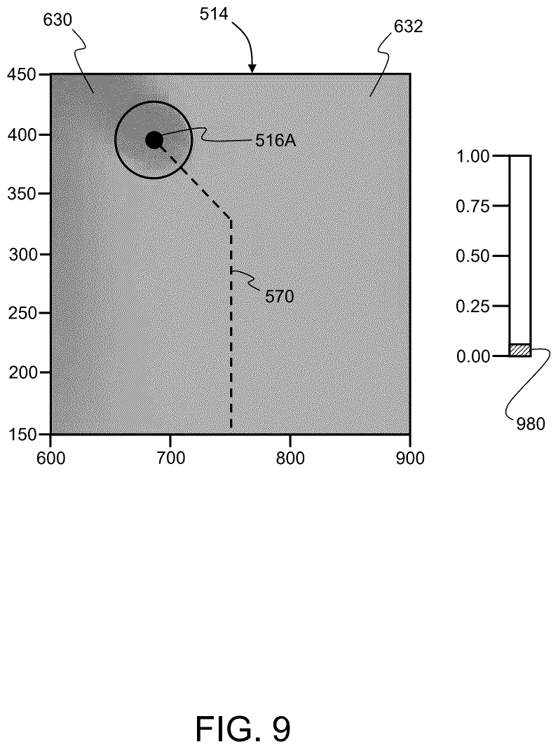

As examples, FIGS. 7-9 schematically represent confidence score diagrams for the regions 510, 512, and 516, respectively, during the mission. At the time that the confidence score diagrams were generated, a first searcher 516A was located in the third region 514 and moving along a path 570 in accordance with the control algorithms of the search mode for the third region 514 (FIG. 9), a second searcher 516B was located in the first region 510 and in track mode tracking a first target 518A (FIG. 7), and a third searcher 516C and a fourth searcher 516D were located in the second region 512 with the third searcher 516C moving along a path 572 in accordance with the control algorithms of the search mode for the second region 512 and the fourth searcher 516D in track mode tracking a second target 518B (FIG. 8). In these examples, the regions 510, 512, and 514 are presented as dynamic heatmaps indicative of the search performed on the corresponding region 510, 512, or 514. For simplicity, the heatmaps are discussed herein as having a recently searched area 630 and an unsearched area 632; however, in various examples the heatmaps may be segmented into various areas (e.g., on a pixel-by-pixel basis) and each of the areas have, for example, a color indicative of various levels of certainty (e.g., an estimated certainty) as to whether the corresponding area potentially includes an undetected target 518. In general, searching each of the areas may increase the estimated certainty for the corresponding area that there are not any undetected targets 518 in the corresponding area. The heatmaps may “backfill” themselves to account for the possibility of undetected targets 518 moving into a previously searched area. That is, the estimated certainty for each of the areas of the heatmap decrease over time after being searched. The rate of the decrease after being searched may vary, for example, based on the predicted mobility of the undetected targets 518.

In these examples, the first region 510 predominately includes the recently searched area 630, the second region 512 includes a mixture of the recently searched area 630 and the unsearched area 632, and the third region 514 predominately includes the unsearched area 632. Based on the heatmaps, each of the regions 510, 512, and 514 may be labeled with a confidence score. For example, the first region 510 may have a high confidence score 780 (e.g., 1) indicating a low likelihood that there are undetected targets 518 therein, the second region 512 may have a medium confidence score 880 (e.g., 0.5) indicating that there may or may not be undetected targets 518 therein, and the third region 514 may have a low confidence score 980 (e.g., 0) indicating that it is generally unknown whether there are undetected targets 518 therein.

At step 428, the method 400 may include determining whether to change the active mode based on the estimation generated by the state estimator. If a determination is made at step 452 that the current track of one of the searchers 516 is not stale, or if a determination is made at step 450 that a new target 518 has been detected, the method 400 may include, at 460, determining whether the searcher 516 should begin tracking the detected target 518. If a determination is made at step 460 that the searcher 516 should begin to track the detected target 518, the method 400 may include maintaining and/or assigning the target 518 to track, at step 462, for that searcher 516. If a determination is made at step 460 that the searcher 516 should not track the target 518, the method 400 may return to step 450.

Once a confidence score has been generated at step 458, the method 400 may include, at step 464, determining whether the regions in which each of the searchers 516 are located within have been sufficiently searched. If a determination is made at step 464 that any of the regions require additional searching, the method 400 may include continuing to search the region, at step 466. If a determination is made, at step 464, that the region has been sufficiently searched, the method 400 may include assigning any of the searchers 516 therein to search another of the regions 510, 512, or 514 with the new assignments being based on the search strategy, at step 468.

Once all assignments have been made at step 428, the method 400 may include changing or maintaining the active mode for one or more of the searchers 516 by activating the corresponding mode, at step 430, for each of the searchers 516 in accordance with confidence-based transition logic and, at step 432, initiating control algorithms and state estimators for the mode(s). Thereafter, the method 400 may return to step 418 to initiate a subsequent action.

The systems and methods disclosed herein provide various benefits over certain existing systems and methods. For example, the systems and methods disclosed herein promote smart executive decision making, which may lead to increased mission success and reduced mission durations. In some examples, the systems and methods disclosed herein are capable of modeling and execution of dynamic, complex, and open-ended missions beyond a sequence of “go to point” behaviors. In some examples, state estimation techniques are used to enable mission operation, despite any lack of theoretic guarantees on hybrid control systems.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “substantially” denotes within 5% to account for manufacturing tolerances. Also, as used herein, the term “about” denotes within 5% to account for manufacturing tolerances.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method, comprising:
receiving, by a controller having one or more processors, input data indicative of one or more objectives of a mission, wherein the mission includes agents performing actions in an operational area;
activating, with the controller, an active mode selected from two or more modes for at least a first agent of the agents, wherein each of the modes include actions that the first agent may perform during the mission and control algorithms for executing each of the actions; and
directing, with the one or more processors of the controller, at least the first agent during the mission by:
initiating a current action selected from the actions of the active mode based on the control algorithms of the active mode in response to activation of the active mode;
receiving and processing sensor data and/or communication data received from one or more of the agents and/or other systems monitoring the operational area in response to completion of the current action;
updating a hybrid state estimator based on the sensor data and/or communication data in response to receiving and processing the sensor data and/or communication data;
generating an estimation of a current state of the mission with the hybrid state estimator in response to completion of the hybrid state estimator update; and
activating one of the two or more modes as the active mode for at least the first agent in accordance with confidence-based transition logic based on the estimation generated by the hybrid state estimator in response to completion of generation of the estimation by the hybrid state estimator.

2. The method of claim 1, wherein initiating the current action includes:
determining which of the actions of the active mode to initiate as the current action based on the control algorithms of the active mode;
transmitting a message to the agents indicative of the current action; and
actuating a physical controller of the first agent to perform the current action.

3. The method of claim 1, further comprising producing the two or more modes, the transition logic for changing between the two or more modes, the hybrid state estimator for generating the estimation of the current state of the mission, and the control algorithms for executing the actions of each of the two or more modes.

4. The method of claim 1, wherein updating the hybrid state estimator includes monitoring a physical state of the agents in the operational area.

5. The method of claim 1, wherein updating the hybrid state estimator includes generating a target model that predicts motion of one or more targets in the operational area.

6. The method of claim 5, wherein the target model includes a hierarchical prediction of where in the operational area detection of potential undetected targets may occur.

7. The method of claim 1, wherein the mission includes searching for one or more targets located within two or more regions of the operational area, wherein the control algorithms include a search algorithm driven by a probabilistic target state estimate.

8. The method of claim 1, wherein the mission includes searching for one or more targets located within two or more regions of the operational area, wherein the control algorithms include a nonmyopic information theoretic search algorithm.

9. The method of claim 1, wherein the mission includes searching for one or more targets located within two or more regions of the operational area, wherein the estimation generated by the hybrid state estimator includes a dynamic heatmap for each of the two or more regions segmented into areas, wherein the heatmap indicates an estimated certainty as to whether undetected targets are located within each of the areas, wherein searching each of the areas increases the estimated certainty for the corresponding area that there are not any undetected targets in the corresponding area, wherein the estimated certainty for each of the areas of the heatmap decrease over time after being searched.

10. The method of claim 1, further comprising, with the one or more processors of the controller:
predicting that the first agent will fail a first objective of the one or more objectives of the mission based on the estimation generated by the hybrid state estimator prior to failure of the first objective; and
requesting or assigning a second agent of the agents to assist the first agent to avoid failure of the first objective.

11. A system, comprising:
two or more agents configured to operate within an operational area during a mission; and
a controller configured to, with one or more processors:
receive input data indicative of one or more objectives of the mission, wherein the mission includes the agents performing actions in the operational area;
activate, for at least a first agent of the agents, an active mode selected from two or more modes, wherein each of the modes include actions that the first agent may perform during the mission and control algorithms for executing each of the actions; and
direct at least the first agent during the mission by:
initiating a current action selected from the actions of the active mode based on the control algorithms of the active mode in response to activation of the active mode;
receiving and processing sensor data and/or communication data received from the one or more of the agents and/or other systems monitoring the operational area in response to completion of the current action;
updating a hybrid state estimator based on the sensor data and/or communication data in response to receiving and processing the sensor data and/or communication data;
generating an estimation of a current state of the mission with the hybrid state estimator in response to completion of the hybrid state estimator update; and
activating one of the two or more modes as the active mode in accordance with confidence-based transition logic based on the estimation generated by the hybrid state estimator in response to completion of generation of the estimation by the hybrid state estimator.

12. The system of claim 11, wherein initiating the current action with the controller includes:
determining which of the actions of the active mode to initiate as the current action based on the control algorithms of the active mode;
transmitting a message to the agents indicative of the current action; and
actuating a physical controller of the first agent to perform the current action.

13. The system of claim 11, wherein the controller is disposed onboard the first agent.

14. The system of claim 11, wherein the controller is disposed within a remote system geographically separate from the two or more agents and in operable communication therewith.

15. The system of claim 11, wherein updating the hybrid state estimator with the controller includes monitoring a physical state of the agents in the operational area.

16. The system of claim 11, wherein updating the hybrid state estimator with the controller includes generating a target model that predicts motion of one or more targets in the operational area.

17. The system of claim 11, wherein the mission includes searching for one or more targets located within two or more regions of the operational area, wherein the control algorithms include a search algorithm driven by a probabilistic target state estimate.

18. The system of claim 11, wherein the mission includes searching for one or more targets located within two or more regions of the operational area, wherein the control algorithms include a nonmyopic information theoretic search algorithm.

19. The system of claim 11, wherein the mission includes searching for one or more targets located within two or more regions of the operational area, wherein the estimation generated by the hybrid state estimator includes a dynamic heatmap for each of the two or more regions segmented into areas, wherein the heatmap indicates an estimated certainty as to whether undetected targets are located within each of the areas, wherein searching each of the areas increases the estimated certainty for the corresponding area that there are not any undetected targets in the corresponding area, wherein the estimated certainty for each of the areas of the heatmap decrease over time after being searched.

20. The system of claim 11, wherein the controller is configured to, with the one or more processors:
predict that the first agent of the agents will fail a first objective of the one or more objectives of the mission based on the estimation generated by the hybrid state estimator prior to failure of the first objective; and
request or assign a second agent of the agents to assist the first agent to avoid failure of the first objective.
